(19) United States
(12) Patent Application Publication
(10) Pub. No.: US 2019/0041868 A1
(43) Pub. Date: Feb. 7, 2019

(54) Autonomous Vehicle-Based Item Retrieval System and Method

(71) Applicant: Walmart Apollo, LLC, Bentonville, AR (US)

(72) Inventors: Robert Cantrell, Herndon, VA (US); Donald R. High, Noel, MO (US); Nathan Glenn Jones, Bentonville, AR (US); Brian Gerard McHale, Oldham (GB)

(21) Appl. No.: 16/053,197

(22) Filed: Aug. 2, 2018

Related U.S. Application Data
(60) Provisional application No. 62/540,762, filed on Aug. 3, 2017.

(51) Int. Cl. G05D 1/02; G06K 7/14; G06Q 30/06

(52) U.S. Cl. CPC G05D 1/0276; G06Q 30/0635; G05D 1/0287; G06K 7/1413

(57) ABSTRACT

An autonomous vehicle-based item retrieval system and method utilizing a logic train autonomous stock picking vehicle that provides support for the picking of items in a facility is discussed. The logic train autonomous stock picking vehicle may utilize sensors to detect a location, a user, obstacles, and the placement of items in the vehicle and may be dispatched as part of a logical group of vehicles forming a “logic train” to meet with a specified individual at a designated location in a facility.

### CROSS-REFERENCE TO RELATED PATENT APPLICATIONS

This application claims priority to U.S. Provisional Application No.: 62/540,762 filed on, Aug. 3, 2017, the content which is hereby incorporated by reference in its entirety.

### BACKGROUND

Autonomous vehicles are able to operate without direct human control. In a facility, autonomous vehicles may navigate using on-board sensors. Different types of autonomous vehicles include ground-based automated guided vehicles (AGVs) and unmanned aerial vehicles (UAVs)/drones.

### BRIEF DESCRIPTION OF DRAWINGS

The accompanying drawings, which are incorporated in and constitute a part of this specification, illustrate one or more embodiments of the invention and, together with the description, help to explain the invention. The drawings should not be considered as a limitation of the present disclosure. In the drawings:

FIG. 1A is a diagram illustrating a logic train autonomous stock picking vehicle deployment in an exemplary embodiment.

FIG. 1B is a diagram illustrating a logic train autonomous stock picking vehicle deployment following a user in an exemplary embodiment.

FIG. 1C is a diagram illustrating a logic train autonomous stock picking vehicle segmented deployment in an exemplary embodiment.

FIG. 2 is a diagram illustrating a logic train autonomous stock picking vehicle with a display device in an exemplary embodiment.

FIG. 3 is a flowchart illustrating an exemplary sequence for deploying a logic train autonomous stock picking vehicle according to an exemplary embodiment.

FIG. 4 is a flowchart illustrating an exemplary sequence for obstacle avoidance for a logic train autonomous stock picking vehicle according to an exemplary embodiment.

FIG. 5 is a block diagram illustrating an exemplary computing device suitable suitable for use in exemplary embodiments.

FIG. 6 is a diagram illustrating a distributed system for controlling multiple logic trains of autonomous stock picking vehicles in an exemplary embodiment.

### DETAILED DESCRIPTION

Described in detail herein is an autonomous vehicle-based item retrieval system and method utilizing a logic train autonomous stock picking vehicle that provides support for the picking of items in a facility such as, but not limited to, a store or distribution center. The logic train autonomous stock picking vehicle may utilize sensors to detect a location, a user, obstacles, and the placement of items in the vehicle and may be dispatched as part of a logical group of vehicles forming a “logic train” to meet with a specified individual at a designated location in a facility.

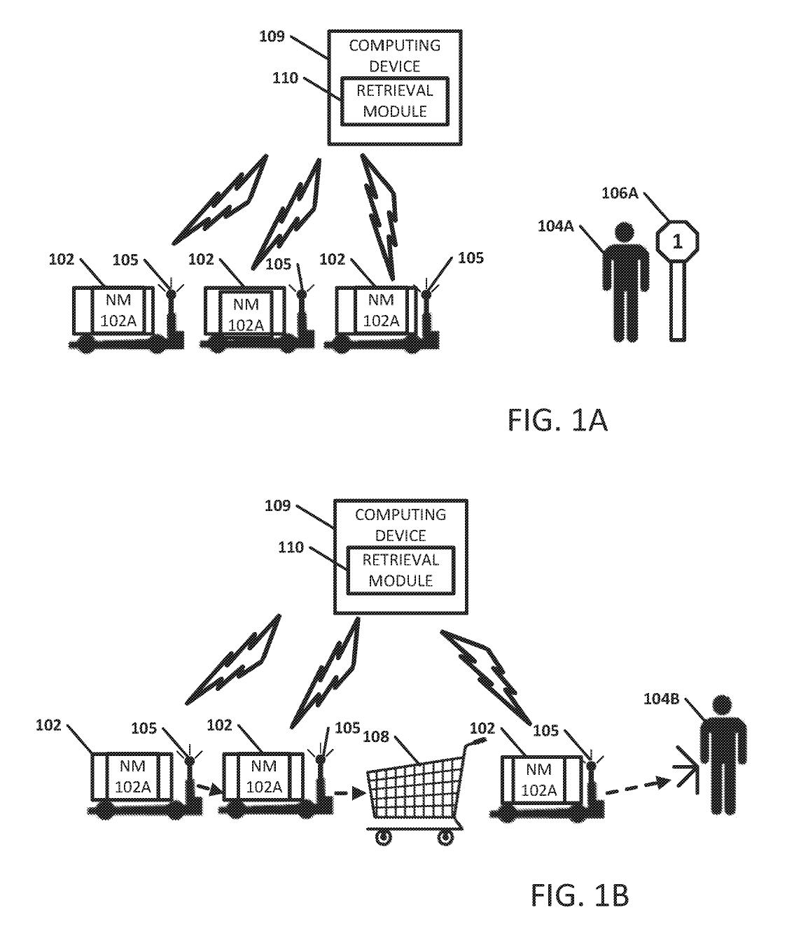

FIG. 1A is a diagram illustrating a logic train autonomous stock picking vehicle 102 deployment according to an exemplary embodiment. The logic train autonomous stock picking vehicle 102 may be deployed in a facility such as, but not limited to a store or distribution center, and may include a powered chassis capable of transporting a multitude of items. Mounted to the powered chassis may be a mechanism and/or container to hold selected items. The items may include dry goods, as well as refrigerated items. Refrigeration equipment may be included within the logic train autonomous stock picking vehicle 102 to hold and maintain refrigerated items without spoilage. For items not needing refrigeration, a basket collector may be included. The basket collector may be of any variety so long as it can accommodate items and may be mounted to the powered chassis. The logic train autonomous stock picking vehicle 102 may include one or more sensors for navigation, an indicator mechanism (described further below) and one or more processors capable of executing one or more processes in a navigation module 102A for navigating the vehicle The logic train autonomous stock picking vehicle 102 may include a wireless communication interface enabling communication with a remotely located computing device associated with the facility such as computing device 109.

Computing device 109 may execute a retrieval module 110. Retrieval module 110 may include one or more computing device-executable processes that when executed retrieve a list of items from one or more storage locations. For example, retrieval module 110 may retrieve a list of items for an online order associated with a specified individual from a database associated with the facility. The retrieval module 110 may transmit the retrieved list via computing device 109 to one or more of a group of logic train autonomous stock picking vehicles 102 in the facility.

In one embodiment, the retrieval module 110 may service a number of stock picking vehicles fulfilling the same or multiple orders. For different orders, the retrieval module 110 may provide the navigation module of each logic train autonomous stock picking vehicle with mapping information indicating a path to follow so as to avoid other stock picking vehicles fulfilling other orders. For multiple autonomous vehicles fulfilling the same order, the retrieval module may transmit lists of different items from a single list to different vehicles and instruct the vehicles to navigate as a logical group to a designated location to meet a specified individual. The retrieval module 110 may access a database containing relevant item location information, as well as access a database containing orders for fulfillment that include item listings of items that need to be picked from shelving in the facility.

For example, the retrieval module 110 may direct the logic train autonomous stock picking vehicle 102 to a designated location in a facility to meet a specified individual at a first position 106A. As described above the actual routing to the first position 106A may be determined by the retrieval module 110 or it may be calculated by the navigation module 102A of the logic train autonomous stock picking vehicle. In one embodiment, the retrieval module 110 may transmit an identifier for the individual to the logic train autonomous stock picking vehicle 102 accompanied by a general location in the facility. As explained further below, the specified individual may wear or control a device broadcasting a signal containing the identifier and the logic train autonomous stock picking vehicle 102 may include an appropriate receiver for detecting the signal. In one non-limiting example, the specified individual may wear a badge or vest containing a beacon transmitting an employee identifier via a radio frequency signal and the logic train autonomous stock picking vehicle may be equipped with an RF receiver to receive the signal. In such a case, the logic train autonomous stock picking vehicle may navigate to an area of the facility, detect the signal and then navigate to the exact location of the individual. At the first position, an individual 104A awaits the stock picking vehicle 102, to retrieve the items identified by the retrieval module 110 and place them in the logic train autonomous stock picking vehicle 102. The navigation module 102A on the logic train autonomous stock picking vehicle 102 may receive information from computing device 109 relating to obstacles, dynamic and static, that may impede the progress of the logic train autonomous stock picking vehicle. Additionally, onboard sensors on the logic train autonomous stock picking vehicle 102 may detect obstacles while in transit. The navigation module 102A may identify routes to each of the list of items, incorporating avoidance of any obstacles into the route that are received from the retrieval module, as well as any obstacles identified by onboard sensors. The navigation module 102A may also receive positional information pertaining to the location of the logic train autonomous stock picking vehicle 102 within the facility through a location-based sensor. The navigation module 102A may map a path based on any received positional information for the logic train autonomous stock picking vehicle 102 as well as the location information for the received items. The navigation module 102A may have access to information regarding the physical layout of the facility. The path may be mapped in a number of ways. The path may be a shortest distance path necessary to collect all of the received item listings. Alternatively the path may be mapped to avoid high traffic areas of the facility, where delays in item collection due to obstacles may be introduced. In another embodiment, the path may be mapped to better utilize the location of human associates in areas of the facility where the received item listings are located.

The logic train autonomous stock picking vehicle 102 may communicate with another logic train autonomous stock picking vehicle 102 through a wireless interface to support proper navigation as demonstrated in FIG. 1A. Alternatively, the logic train autonomous stock picking vehicle 102 may include a wired connection between another the logic train autonomous stock picking vehicle 102 coupling one or more logic train autonomous stock picking vehicle(s) 102 like a traditional train. The traditional train embodiment may include communication from one logic train autonomous stock picking vehicle 102 at the logical front of the train, to the other logic train autonomous stock picking vehicle(s) 102 in the train through the wired connection between each of the logic train autonomous stock picking vehicle(s) 102. Additionally, non autonomous vehicles may be included in the logic train. Non-autonomous vehicles, such as a shopping cart or mobile cooler cart, may be coupled to a logic train autonomous stock picking vehicle 102 to support the picking and transport of additional items. In another embodiment, all communication to support navigation of the logic train autonomous stock picking vehicle 102 may be relayed through the retrieval module 110 to another logic train autonomous stock picking vehicle 102.

Upon arrival at the designated location, the logic train autonomous stock picking vehicle(s) 102 may convey their respective list information to the specified individual in different manners. As noted above, the logic train autonomous stock picking vehicle(s) 102 may include an indicator mechanism 105. The indicator mechanism 105 may be a display device or an audio mechanism. The display device may display items to be retrieved. Alternatively, or in addition, the audio mechanism may verbally broadcast the name or other indicator for an item from the list. In one embodiment, the audio mechanism includes a microphone enabling bi-directional communication between the specified individual and a third party in communication via the computing device 109. After being informed of the identity of the item, the specified individual may retrieve the item from a storage location in the facility, such a shelf, and place the retrieved item in the logic train autonomous stock picking vehicle(s) 102. Items placed in the logic train autonomous stock picking vehicle 102 may be detected and verified in a number of ways. A bar code scanner may be used to scan the Universal Product Code (UPC) printed on the package of the item to uniquely identify that item. Additionally, a weight sensor may be employed to validate the weight of the item against a known weight value of the item placed in the stock picking vehicle. Further, image recognition software may detect the proper item placed in the logic train autonomous stock picking vehicle 102 by capturing an image of the item, processing it to identify key characteristics of the item packaging, and correlating the key characteristics with known characteristics of the item to be selected. It should be understood that other types of verification are also within the scope of the present invention.

FIG. 1B is a diagram illustrating a logic train autonomous stock picking vehicle deployment following a user according to an exemplary embodiment. FIG. 1B is an alternative embodiment of the logic train autonomous stock picking vehicle 102 in FIG. 1A. In this embodiment, the logic train autonomous stock picking vehicle 102, operates in a “follow me” mode, where the user 104B walks across the store with the stock picking vehicle 102 autonomously following the user. The user 104B may carry a beacon, as illustrated in FIG. 1B or may be recognized in a number of ways including but not limited to video recognition. The beacon may be visible light, infra-red, or radio frequency. Accordingly, a sensor adapted to detect the beacon or the user himself or herself may be included on the logic train autonomous stock picking vehicle 102.

Additionally, the logic train autonomous stock picking vehicle 102 may be equipped to avoid obstacles 108 including but limited to shopping carts, other logic train autonomous stock picking vehicles 102, and users. The logic train autonomous stock picking vehicle 102 may detect the obstacle 108 through sensors designed to detect using infrared, ultrasonic, and image processing. Unobstructed logic train autonomous stock picking vehicles 102 may continue to follow the user 104B. Obstructed logic train autonomous stock picking vehicles 102 may rejoin any unobstructed logic train autonomous stock picking vehicles 102 upon the removal or rerouting around the obstacle 108. An obstructed logic train autonomous stock picking vehicle 102 may reroute based on information detected through the sensors, indicating a clear path. Alternatively, the obstructed logic train autonomous stock picking vehicle 102 may accept navigation information from the retrieval module 110 to reroute around the obstacle 108 and to rejoin the unobstructed stock picking vehicles 102.

FIG. 1C is a diagram 100C illustrating a logic train autonomous stock picking vehicle with a segmented deployment according to one exemplary embodiment. The logic train autonomous stock picking vehicles 102 of a logic train may separate and deploy to different locations within a facility. In an embodiment, the retrieval module 110 may provide a list of mutually exclusive items to each of the logic train autonomous stock picking vehicles 102. The logic train autonomous stock picking vehicles 102 may autonomously deploy to their respective locations 106A, 106B, 106C where a retrieval mechanism on the logic train autonomous stock picking vehicle 102 may retrieve items. Alternatively, the logic train autonomous stock picking vehicles 102, may autonomously navigate a path utilizing a navigation module to the received item lists. Upon reaching the respective locations 106A, 106B, 106C, a respective individual 112A, 112B, 112C facilitates the loading of the items on the item list into the logic train autonomous stock picking vehicle. Alternatively, the logic train autonomous stock picking vehicles 102 may separate to their respective locations and await a single specified individual to walk between each location and retrieve and store items in the vehicles. Upon completion of the processing of their item list, the logic train autonomous stock picking vehicles 102 may rejoin and return to a receiving area or base station, return to a receiving area or base station independently, or partially reform and return.

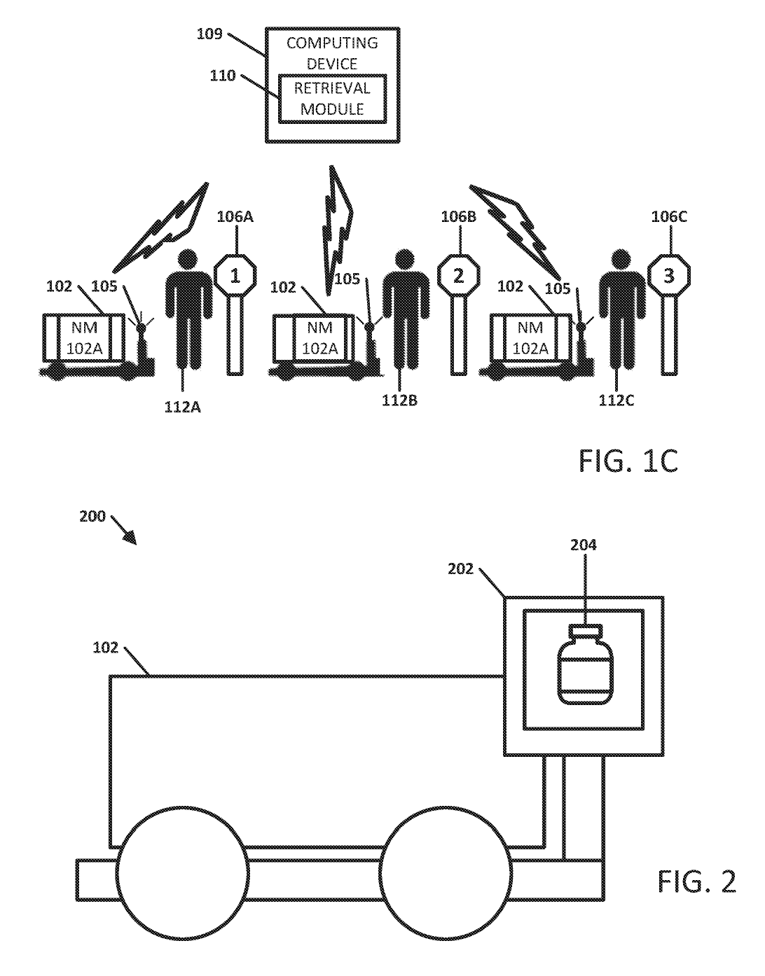

FIG. 2 is a diagram 200 illustrating a logic train autonomous stock picking vehicle 102 with a display device 202 according to an exemplary embodiment. The logic train autonomous stock picking vehicle 102 may be equipped with a display device 202 to inform the user as to which item needs to be selected and placed in the stock picking vehicle 102. The display device 202 may indicate the desired item 204 in graphic form, textual form or a combination of the two, where the graphic may be a photo or interactive rendering, and the textual form may be a description as to item size, weight, and contents. The display device 202 may be any device capable of displaying the desired item 204, including but not limited to cathode ray tubes, liquid crystal displays, and light emitting diode displays. Capacitive touch displays, keyboards, and buttons may also be utilized to allow an interaction between the display device and the user. Upon verification of the storage of the correct item (e.g. by scanner, weight sensor, image recognition, etc.), the display device 202 may present another item located in the vicinity to be placed in the autonomous vehicle. However, if the placement of an incorrect item occurs, the display device 202 may alert the user in a visual manner. The display device 202 may present textual or graphical information indicating that the placed item is incorrect, and a description as to why the item is incorrect. For example, if an item is placed in the autonomous vehicle detects that the item is incorrect, the display device 202 may provide a textual warning indicating that the incorrect sized package of the item was placed in the logic train autonomous stock picking vehicle.

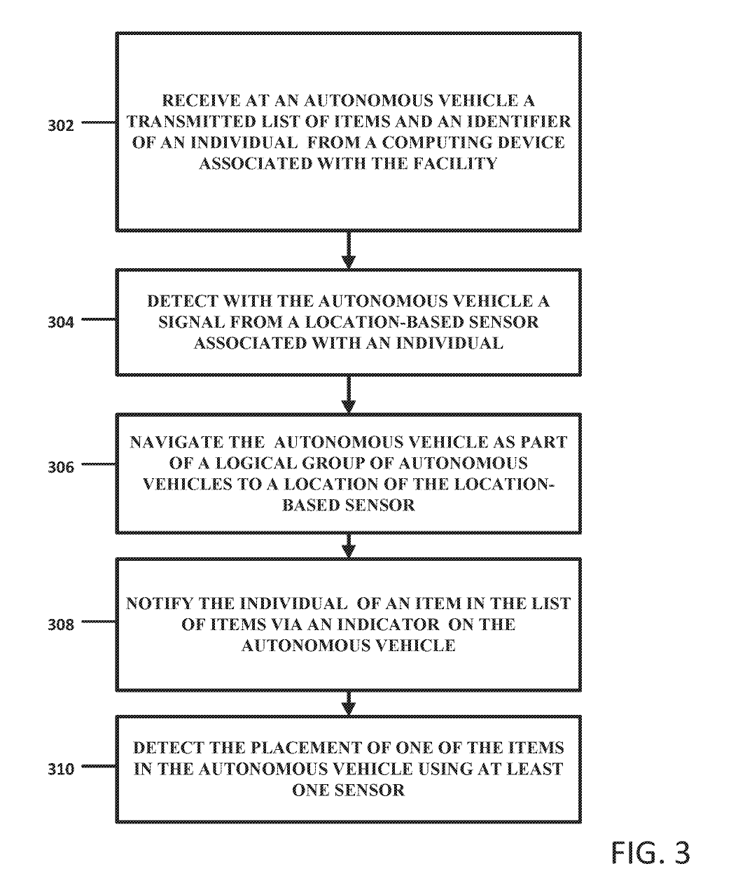

FIG. 3 is a flowchart illustrating an exemplary sequence for deploying a logic train autonomous stock picking vehicle according to an exemplary embodiment. At step 302, a transmitted list of items and an identifier of a specified individual are received via a communication interface on a logic train autonomous stock picking vehicle where the listing and the identifier are transmitted from a computing device associated with the facility to the logic train autonomous stock picking vehicle. The communication interface may be a networking interface operable to receive and process transmissions based on communication protocols. The communication protocols may include 802.11, ZigBee®, Bluetooth™, or any other protocol capable of propagating the transmission. The transmitted list of items may include items located within the facility. The identifier may include a beacon identifier associated with an individual. The beacon signal may provide the logic train autonomous stock picking vehicle with a transmission which the logic train autonomous stock picking vehicle can detect. In one embodiment, the beacon may include a radio transmitter. As non-limiting examples, the beacon may be attached to clothing worn by the individual or be a handheld device that the individual carries. The beacon's transmissions may provide a unique identifier that may be received by the logic train autonomous stock picking vehicle. Alternatively, instead of being broadcast the identifier may be biometric data corresponding to an individual that may be compared to images captured and processed by the logic train autonomous stock picking vehicle. The transmitted list and identifier may be stored in memory local to the logic train autonomous stock picking vehicle.

At step 304, a signal from a location-based sensor associated with the individual is detected with the logic train autonomous stock picking vehicle. In one embodiment, the signal may be a transmission from a beacon. The signal may include an indicator in the visible spectrum of light. The uniqueness of the signal to indicate the user may take the form of protocol defining patterns and intensities of the transmissions which the autonomous vehicle can detect and interpret. Alternatively, the signal may include an indicator in a non-visible spectrum of light implementing a similar protocol. Further the signal may be a radio signal including the identifier.

At step 306, the logic train autonomous stock picking vehicle navigates as part of a logical group of autonomous vehicles to a location of the location-based sensor. In one embodiment, a logic train autonomous stock picking vehicle may generate a route from the current location of the logic train autonomous stock picking vehicle to the location-based sensor. The logic train autonomous stock picking vehicle may utilize a positioning system within the facility to determine its position relative to the interior of the facilities. Based on transmissions from the positioning system within the facility and known topology of the facility, the logic train autonomous stock picking vehicle may plot a course through the facility to the location-based sensor.

At step 308, an indicator on the logic train autonomous stock picking vehicle notifies the specified individual of an item in the list of items. In an embodiment, the autonomous stock picking vehicle provides visual display, through a display device indicating the item to be selected. The display device may include textual descriptions including the item price, brand name, unit size, quantity, and item description. As described in FIG. 2, the display device can take many forms. Once the item is displayed, the specified individual may retrieve/pick the item from the place where it is shelved, and place it in a collector attached to the logic train autonomous stock picking vehicle. The collector attached to the logic train autonomous stock picking vehicle may be a basket, a cooler for refrigerated items, a flatbed for large or bulky items, or other storage mechanism. In another embodiment, the logic train autonomous stock picking vehicle may detect the item on shelving, either through the use of recognition software, or UPC bar code scanners. In an embodiment, the logic train autonomous stock picking vehicle may include a robotic arm capable of manipulating the item, and placing it in a collector on the autonomous vehicle.

At step 310, the logic train autonomous stock picking vehicle uses at least one sensor to detect the placement of one of the items in the logic train autonomous stock picking vehicle. For example, a bar code scanner may detect the placement of the item in the collector. Upon the placement of the item in the collector, a bar code scanner scans the code on the item. The bar code is checked against the expected bar code of the item to determine if the correct item was placed in the collector. Alternatively, a weight sensor may be employed to determine placement in the collector. After the item is placed in the collector, the weight sensor verifies that a detected weight matches the item that was supposed to be retrieved. Once, it is determined that the correct item has been placed in the collector, the logic train autonomous stock picking vehicle updates the indicator, or display device, of the next item on the list that is in the area, or the logic train autonomous stock picking vehicle proceeds to navigate to the next location based sensor.

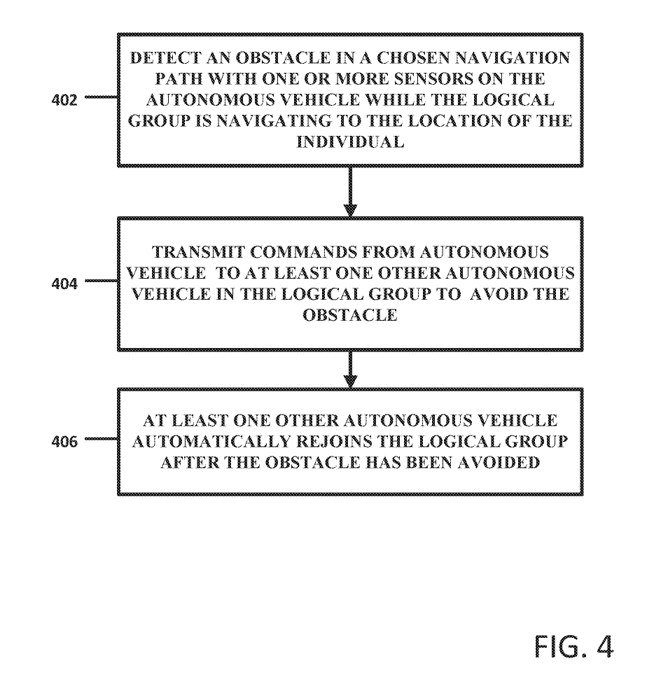

FIG. 4 is a block diagram illustrating an exemplary sequence for obstacle avoidance for a logic train autonomous stock picking vehicle according to an exemplary embodiment. At step 402, the logic train autonomous stock picking vehicle detects, with one or more sensors, an obstacle in a chosen navigation path while the logical group is navigating to the location of the individual. In one embodiment, the logic train autonomous stock picking vehicle includes optical sensors and dedicated hardware and software utilized for processing images obtained through the optical sensors. In another embodiment, the logic train autonomous stock picking vehicle may implement LIDAR and RADAR ranging technologies to improve obstacle detection and navigation.

At step 404, the logic train autonomous stock picking vehicle transmits based on the detecting, commands to at least one other autonomous vehicle in the logical group to avoid the obstacle. The logic train autonomous stock picking vehicle may transmit directly to other logic train autonomous stock picking vehicles in the logical group details about the obstacle. Alternatively, the logic train autonomous stock picking vehicle may transmit to a retrieval module 110 that relays information regarding the obstacle to one or more logic train autonomous stock picking vehicle in the logical group, or other logical groups. Navigation on every logic train autonomous stock picking vehicle may then be updated to avoid the obstacle, or any bottlenecks on the facility floor created by the obstacle.

At step 406, at least one other logic train autonomous stock picking vehicle automatically rejoins the logical group after the obstacle has been avoided. Upon obstacle avoidance, any remaining logic train autonomous stock picking vehicles navigate to the position of the logical group. A retrieval module 110 may collect information about the location and state of each of the logic train autonomous stock picking vehicle in the logical group. Additionally the retrieval module 110 may transmit data regarding the location and state of a single logic train autonomous stock picking vehicle to the remaining logic train autonomous stock picking vehicle in the logical group.

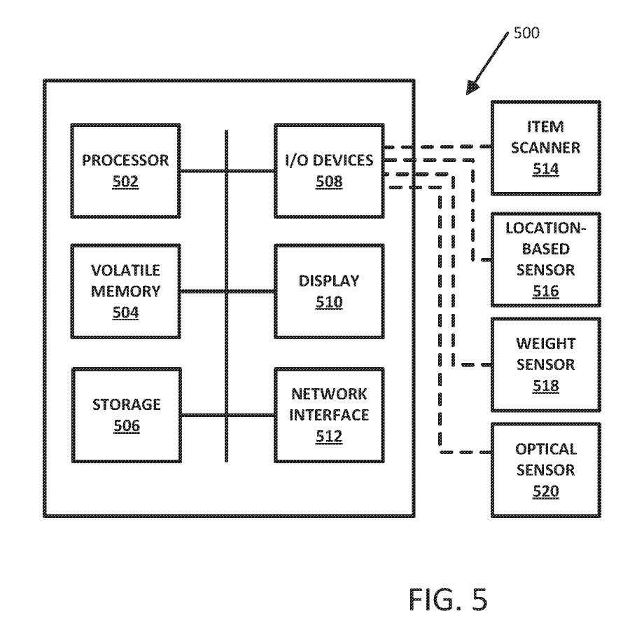

FIG. 5 is a block diagram illustrating an exemplary computing device suitable for use in exemplary embodiments. Computing device 500, such as computing device 109, may support the execution of a retrieval module supporting a logic train autonomous stock picking vehicle. Similarly, the logic train autonomous stock picking vehicle 102 may include a computing device with one or more processors executing a navigation module as described herein. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, volatile memory 504 included in the computing device 500 may store computer-readable and computer-executable instructions or software (e.g., mobile applications) for implementing exemplary operations of the computing device 500. The computing device 500 also includes configurable and/or programmable processor 502 for executing computer-readable and computer-executable instructions or software stored in the volatile memory 504 and other programs for implementing exemplary embodiments of the present disclosure. Processor 502 may be a single core processor or multiple core processors. Processor 502 may be configured to execute one or more of the instructions described in connection with computing device 500.

Volatile memory 504 may include a computer system memory or random access memory, such as DRAM, SRAM, EDO RAM, and the like. Volatile memory 504 may include other types of memory as well, or combinations thereof.

A user may interact with the computing device 500 through a display 510, such as a computer monitor, which may display one or more graphical user interfaces supplemented by I/O devices 508, which may include a multi touch interface, a pointing device, an image capturing device and a reader. Additionally, I/O devices 508 may include an item scanner 514, a location-based sensor 516, a weight sensor 518, and an optical sensor 520. The item scanner 514 may take the form of UPC bar code scanners or Quick Response (QR) code readers. The location-based sensor 516 may be a sensor capable of receiving Global Positioning Satellite (GPS) system signals. Alternatively, the location-based sensor 516 may be capable of receiving multiple signals and triangulating a relative position based on observed differences in the signals. A weight sensor 518 may be among the attached I/O devices 508. The weight sensor may take the form of a scale used for the detection of items placed in the collector. An optical sensor 520 may also be attached among the I/O devices 508. The optical sensor may be a charge-coupled device (CCD) imaging sensor, an active-pixel sensor (APS), or an equivalent. Image processing hardware or software may be inclusive to the optical sensor 520, or alternatively, image processing software may execute on the host processor 502. The optical sensor 520 assists the autonomous vehicle in obstacle detection and navigation.

The computing device 500 may also include storage 506, such as a hard-drive, CD-ROM, or other computer readable media, for storing data and computer-readable instructions and/or software that implement exemplary embodiments of the present disclosure (e.g., applications). For example, storage 506 may include the list of items to be collected, media containing description of the items to be collected, non-volatile software stored for obstacle detection, as well as information identifying which logical group the autonomous vehicle belongs.

The computing device 500 can include a network interface 512 configured to interface via one or more network devices with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the network interface 512 may include one or more antennas to facilitate wireless communication between the computing device 500 and a network and/or between the computing device 500 and other computing devices. The network interface 512 may include a built-in network adapter, network interface card, PCMCIA network card, card bus network adapter, wireless network adapter, USB network adapter, modem or any other device suitable for interfacing the computing device 500 to any type of network capable of communication and performing the operations described herein.

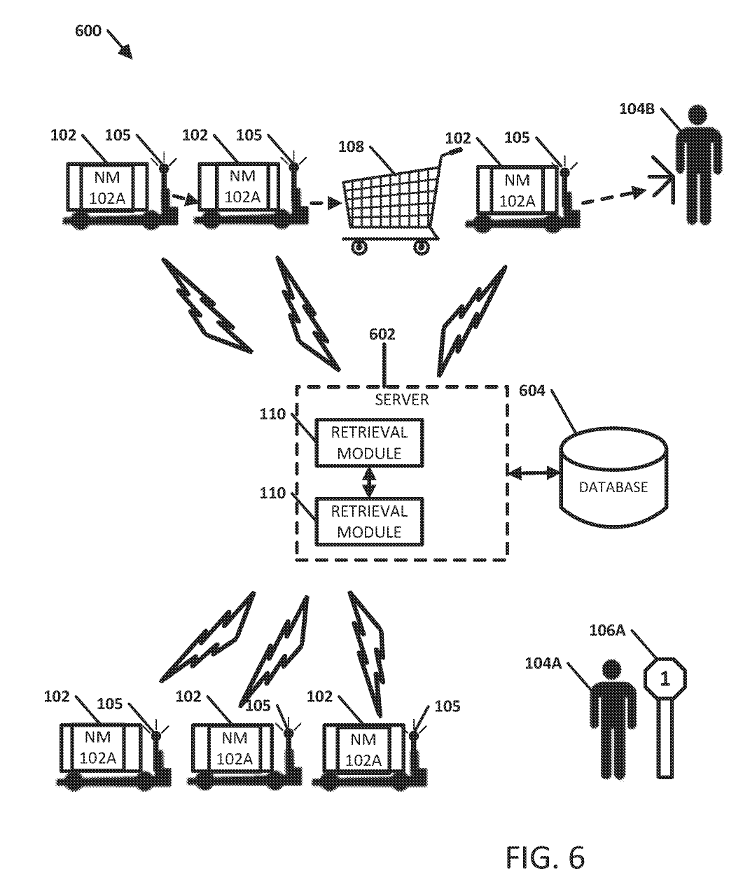

FIG. 6 is a diagram 600 illustrating a distributed system for controlling multiple logic trains of autonomous stock picking vehicles according to an exemplary embodiment. In one embodiment, a server 602 hosts one or more retrieval modules 110. The server 602 may be a physical computer operating with dedicated computing resources for executing the retrieval modules 110. Alternatively, the server 602 may be a virtualized environment in which physical resources are shared across many virtualized servers. In the virtualized environment, the retrieval modules 110 may not execute on the same virtualized server, but instead on different virtualized servers. The server 602 may include resources for supporting the transmission of item list information to the logic train autonomous stock picking vehicles 102. The server 602 may additionally provide navigational information to the logic train autonomous stock picking vehicle 102 corresponding to one or more logical groups. One or more databases 604 may be accessible by the server 602. The database may include data relating to item availability, item location, item description as well as known obstacles in the facility and current locations of users within the facility.

Portions or all of the embodiments of the present invention may be provided as one or more computer-readable programs or code embodied on or in one or more non-transitory mediums. The mediums may be, but are not limited to a hard disk, a compact disc, a digital versatile disc, a flash memory, a PROM, a RAM, a ROM, or a magnetic tape. In general, the computer-readable programs or code may be implemented in many computing languages.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. An autonomous vehicle-based item retrieval system for a facility, the system comprising:
a location-based sensor associated with an individual;
a retrieval module executable on a computing device, the retrieval module when executed:
retrieving a listing of a plurality of items from one or more storage locations, and
transmitting the listing of the plurality of items to at least one a plurality of autonomous vehicles in the facility, and
the plurality of autonomous vehicles, each equipped with:
one or more processors,
one or more sensors, and
an indicator mechanism;
wherein the one or more processors in each autonomous vehicle are configured to execute a navigation module that when executed:
receives the listing of the plurality of items and an identifier of the individual from the retrieval module;
detects a signal from the location-based sensor,
navigates the autonomous vehicle as part of a logical group of the plurality of autonomous vehicles to a location of the location-based sensor,
notifies the individual via the indicator mechanism of an item on the list of the plurality of items, and
detects a placement of one of the plurality of items in the autonomous vehicle using at least one of the one or more sensors.

2. The system of claim 1 wherein the indicator mechanism is a display screen.

3. The system of claim 1 wherein the indicator mechanism is an audio mechanism enabling bi-directional communication between the individual and a third party.

4. The system of claim 1 wherein the one or more sensors are configured to detect an obstacle in a chosen navigation path while the logical group is navigating to the location of the individual and the navigation module when executed transmits commands to at least one other autonomous vehicle in the logical group to avoid the obstacle, wherein the at least one autonomous vehicle automatically rejoins the logical group after the obstacle has been avoided.

5. The system of claim 1 wherein at least one of the one or more sensors is a bar code scanner.

6. The system of claim 1 wherein at least one of the one or more sensors is a weight sensor.

7. The system of claim 1 wherein the location-based sensor is a beacon.

8. A method for performing autonomous vehicle-based item retrieval in a facility comprising:
receiving via a communication interface on a selected one of a plurality of autonomous vehicles a transmitted listing of a plurality of items and an identifier of an individual, the listing and the identifier transmitted from a computing device associated with the facility to the selected one of the plurality of autonomous vehicles;
detecting with the selected one of the plurality of autonomous vehicles a signal from a location-based sensor associated with the individual;
navigating the selected one of the plurality of autonomous vehicles as part of a logical group of autonomous vehicles to a location of the location-based sensor;
notifying the individual via an indicator mechanism on the selected one of the plurality of autonomous vehicles of an item in the listing of the plurality of items; and
detecting a placement of one of the plurality of items in the selected one of the plurality of autonomous vehicles using at least one sensor.

9. The method of claim 8 wherein the indicator mechanism is a display screen.

10. The method of claim 8 wherein the indicator mechanism is an audio mechanism enabling bi-directional communication between the individual and a third party.

11. The method of claim 8, further comprising:
detecting an obstacle in a chosen navigation path with one or more sensors on the selected autonomous vehicle while the logical group is navigating to the location of the individual;
transmitting, based on the detecting, commands from the selected at least one autonomous vehicle to at least one other autonomous vehicle in the logical group to avoid the obstacle;
wherein the at least one other autonomous vehicle automatically rejoins the logical group after the obstacle has been avoided.

12. The method of claim 8 wherein the at least one sensor detecting a placement of an item is a bar code scanner.

13. The method of claim 8 wherein the at least one sensor detecting a placement of an item is a weight sensor.

14. The method of claim 8 wherein the location-based sensor is a beacon.

15. An autonomous vehicle-based item retrieval system for a facility, the system comprising:
a location-based sensor associated with an individual;
a first autonomous vehicle with a powered chassis operable to transport one or more items, the first autonomous vehicle including:
one or more processors,
an item scanner, and
a display screen providing a bi-directional communication system,
wherein the one or more processors are configured to execute a navigation module to:
receive a listing of the plurality of items and an identifier of the individual;
detect a signal from the location-based sensor,
navigate the first autonomous vehicle as part of a logical group of a plurality of autonomous vehicles to a location of the location-based sensor,
notify the individual via the display screen of an item on the list of the plurality of items, and
detect a placement of one of the plurality of items in the first autonomous vehicle using the item scanner.

16. The system of claim 15 wherein one or more sensors on the first autonomous vehicle are configured to detect an obstacle in a chosen navigation path while the logical group is navigating to a location of the individual and to transmit commands to at least one other autonomous vehicle in the logical group to avoid the obstacle wherein the at least one other autonomous vehicle automatically rejoins the logical group after the obstacle has been avoided.

17. The system of claim 15 wherein the item scanner is a bar code scanner.

18. The system of claim 15 wherein the first autonomous vehicle includes a weight sensor used to detect a location for a placement of the item on the first autonomous vehicle.

19. The system of claim 15 wherein the location-based sensor is a beacon.

20. The system of claim 15 wherein the navigation module is further configured to:
detect a met capacity of items placed on the chassis,
receive a navigation path to a base station,
separate from the logical group, and
navigate to the base station.
